(19) United States
(12) Patent Application Publication
(10) Pub. No.: US 2026/0002691 A1
(43) Pub. Date: Jan. 1, 2026

(54) Multi-Space Learning Building Control

(71) Applicant: Massachusetts Institute of Technology, Cambridge, MA (US)

(72) Inventors: You Lin, Cambridge, MA (US); Leslie Keith Norford, Cambridge, MA (US); Audun Botterud, Cambridge, MA (US); Jeremy Ryan Gregory, Cambridge, MA (US); Joseph A. Higgins, Cambridge, MA (US); Daisy Hiraki Green, Cambridge, MA (US); Kevin J. Kircher, Cambridge, MA (US); Francis Selvaggio, Cambridge, MA (US)

(21) Appl. No.: 19/249,173

(22) Filed: Jun. 25, 2025

Related U.S. Application Data
(60) Provisional application No. 63/665,248, filed on Jun. 27, 2024.

(51) Int. Cl. F24F 11/63; G05B 13/02

(52) U.S. Cl. CPC F24F 11/63; G05B 13/027

(57) ABSTRACT

An approach to optimizing heating, ventilation, and air conditioning (HVAC) temperature setpoints in multi-zone buildings uses a graph-based reinforcement learning framework enhanced with transfer learning. A thermal interaction graph is constructed from spatially distributed building zones, where nodes represent individual rooms or spaces and edges represent thermal or physical relationships. Environmental and operational data, including occupancy, temperature, and weather conditions, are encoded into the graph and processed by a graph neural network to generate a dynamic thermal state representation. A reinforcement learning agent is trained using this representation to learn control policies that adjust HVAC setpoints in real time to minimize energy consumption while maintaining occupant comfort. Transfer learning techniques are employed to adapt pretrained models from one building or zone configuration to another, significantly reducing training time and improving scalability across diverse building types. The system integrates with building management systems (BMS) via programmable interfaces, enabling real-time setpoint optimization.

### CROSS-REFERENCES TO RELATED APPLICATIONS

This application claims the benefit of U.S. Provisional Application No. 63/665,248, filed on Jun. 27, 2024, titled “Multi-Space Building Control Optimization based on Graph Learning and Reinforcement Learning,” the contents of which are incorporated herein by reference.

### BACKGROUND OF THE INVENTION

This invention relates to building control, and more particularly to machine learning based control.

Heating, Ventilation, and Air Conditioning (HVAC) systems are responsible for a significant portion of energy consumption and carbon emissions in buildings. Traditional HVAC control methods rely on rule-based or model-predictive strategies, which often fail to account for complex thermal interactions across multiple zones in a building and lack adaptability to changing conditions like occupancy or weather.

While white-box physical models such as EnergyPlus® or simplified grey-box models (e.g., resistor-capacitor networks) can describe thermal dynamics of a building, they are difficult to scale or adapt in real-time. Similarly, previous efforts in using rule-based or even model-predictive control struggle with high dimensionality, nonlinear behavior, multi-zone coordination, and lack of zone-level energy use or carbon emission measurements.

There remains a need for a scalable, adaptive, and data-driven method to optimize HVAC setpoints dynamically across multiple zones in a building to reduce energy consumption and greenhouse gas emissions without compromising occupant comfort and zone-level energy and or carbon emission information.

### SUMMARY OF THE INVENTION

In one aspect, in general, an AI-powered system and method for optimizing heating and cooling setpoints in multi-space buildings uses a combination of graph learning, reinforcement learning (RL), and/or transfer learning. The system constructs a graph-based thermal model of a building from spatial layouts, where nodes represent rooms or zones and edges capture thermal interactions between those rooms/zones. Building-level aggregated energy usage or carbon emissions are used in the thermal model.

A graph neural network (GNN) is used to encode zone-specific features, such as occupancy, temperature, and environmental data, into a dynamic representation of the building's thermal state. A deep reinforcement learning (DRL) agent learns an optimal control policy that adjusts HVAC setpoints to minimize energy consumption while satisfying thermal comfort constraints. Transfer learning techniques allow pretrained models from one building or configuration to be adapted to another, reducing training time and increasing scalability across diverse environments.

The system can integrate with Building Management Systems (BMS) through APIs, enabling real-time setpoint updates based on sensor and environmental data. Preliminary deployments, such as in a college campus of classrooms and office buildings, demonstrated energy savings of over 30%, validating the system's effectiveness in reducing both energy use and greenhouse gas emissions.

In one aspect, in general, a method of environmental control of spaces in one or more buildings includes determining a graph-based representation of the one or more buildings. This representation includes nodes corresponding to spaces and edges representing adjacency of spaces. A first graph convolutional neural network is configured according to the graph-based representation to receive space-specific features. These features include environmental measurements for respective spaces. The graph convolutional neural network provides environmental control inputs to an environmental control system for spaces. The method includes a repetition for successive time steps that includes receiving environmental measurements for respective spaces, determining inputs to the first graph convolutional neural network from the received environmental measurements, using the first graph convolutional neural network to determine the environmental control inputs for the environmental control system, and providing the environmental control inputs to the environmental control system. For at least some of the time steps, the method includes receiving aggregated energy-related measurements for the one or more buildings, determining a quantity characterizing a quality of response to the environmental control inputs and the energy-related measurements, and updating values of configurable parameters of the first graph convolutional neural network to improve the quality of response in future time steps.

Aspects can include one or more of the following features.

The environmental control system comprises a heating, ventilation, and air conditioning (HVAC) system, and the environmental control inputs comprise temperature setpoints for said HVAC system.

The updating of the configurable parameters of the first graph neural network comprises applying a reinforcement learning procedure using reward values determined from the quantity characterizing the quality of the response for successive time steps.

The reward values each represents a weighted combination of a comfort term and an energy term.

Using the first graph convolutional neural network to determine the environmental control inputs includes using an actor-critic approach in which the first graph convolutional neural network implements an actor network, and a second graph convolutional neural network implements a critic network.

Determining the graph-based representation comprises processing an architectural layout of the one or more buildings. The processing of the architectural layout can include applying a computer-implemented transformation of the architectural layout to produce the graph-based representation.

At least some nodes of the building representation represent outside spaces adjacent to indoor spaces.

The method includes controlling environments of respective spaces using controller of the environmental control system with the environmental control inputs.

Providing the environmental control inputs to the environmental control system comprises providing said inputs via an application programming interface for the environmental control system.

Determining the inputs for the first graph convolutional neural network for spaces includes using one or more of external temperatures, interior temperatures, target temperatures, a CO₂ level, and occupancy information for respective spaces.

The quantity characterizing a quality of response depends on one or more of an achieved temperature, an energy usage, and a CO₂ production for respective spaces.

The method can further include determining a second graph-based representation of a second building separate from the one or more buildings, said representation including nodes corresponding to spaces and edges representing adjacency of spaces of said second building, and configuring a second graph convolutional neural network according to the second graph-based representation, including using configurable parameters of the first graph convolutional neural network to initialize configurable parameters of said second graph convolutional neural network.

In another aspect, in general, a system for environmental control of spaces in one or more buildings includes a learning controller configured according to a graph-based representation of the one or more buildings. This representation includes node corresponding to spaces and edges representing adjacency of spaces. The controller includes an interface for communicating with an environmental control system for the one or more buildings, with the interface providing control inputs to said environmental control system and for receiving at least some environmental measurements for spaces of the one or more buildings. The controller also includes storage for static features and learned parameters of a first graph convolutional neural network configured according to the graph-based representation, an actor for processing environmental measurements using the first graph convolutional neural network to yield control inputs for providing to the environmental control system, and a learner for updating the learned parameters using the environmental measurements. The controller is configured to repeat for successive time steps, receiving environmental measurements for respective spaces, determining inputs to the first graph convolutional neural network from the received environmental measurements, using the first graph convolutional neural network to determine the environmental control inputs for the environmental control system, and providing the environmental control inputs to the environmental control system. The controller is configured to repeat for at least some of the time steps, determining a quantity characterizing a quality of response to the environmental control inputs, and updating values of configurable parameters of the first graph convolutional neural network to improve the quality of response in future time steps.

In another aspect, in general, a method for optimizing heating, ventilation, and air conditioning (HVAC) temperature setpoints in a multi-zone building makes use of a graph representation constructed for the building in which nodes correspond to individual thermal zones and edges represent thermal or spatial relationships between the zones. Zone-specific data including temperature, occupancy, and environmental conditions, is collected, as is building-level aggregated energy usage or carbon emission information instead of zone-level measurements. The graph representation is encoded using a graph neural network to generate a dynamic state representation of the building. A reinforcement learning agent is trained using the dynamic state representation to learn a control policy for adjusting HVAC temperature setpoints. The control policy is applied to update temperature setpoints in real time through a building management system (BMS).

Aspects can include one or more of the following features.

Transfer learning is used to adapt the trained model to one or more additional buildings or zone configurations to reduce training time and increase scalability.

The graph neural network comprises a graph convolutional network (GCNN).

The reinforcement learning agent uses a deep reinforcement learning algorithm selected from the group consisting of proximal policy optimization (PPO), deep Q-learning (DQN), or actor-critic methods.

The reward function used in reinforcement learning is a weighted sum of energy consumption and occupant discomfort.

The graph representation is constructed from architectural layout or sensor metadata.

The system receives real-time updates from building sensors, including room temperature, occupancy counts, and outdoor weather conditions.

The method includes retraining the reinforcement learning agent using updated operational data to improve policy performance over time.

The transfer learning comprises fine-tuning a pre-trained model using a reduced number of training episodes or samples from a new building or layout.

The control policy is deployed through an API interface with the building's existing automation or energy management platform.

The graph-based representation includes thermal interactions inferred from historical temperature dynamics and HVAC system responses.

An advantage of one or more aspects is that energy related measurements, such as energy usage or emission amounts, are only needed at an aggregate level (e.g., at a building level) and the policy can be updated to meet both aggregate comfort at a zone-by-zone basis as well as energy targets at an aggregate level. Furthermore, building-specific characteristics, which may depend on specific building techniques or specific usage characteristics can be automatically learned for a build, and furthermore can be transferred to control other similar buildings with little or no further training being required.

Other features and advantages of the invention are apparent from the following description, and from the claims.

### BRIEF DESCRIPTION OF THE DRAWINGS

FIG. 1 is a block diagram of a building control system;

FIG. 2 is a reinforcement learning arrangement of the building control system;

FIG. 3 is a schematic diagram of a building and a corresponding graph representation; and

FIG. 4 is an illustration of computations for a deep graph convolutional neural network (GCNN).

### DETAILED DESCRIPTION

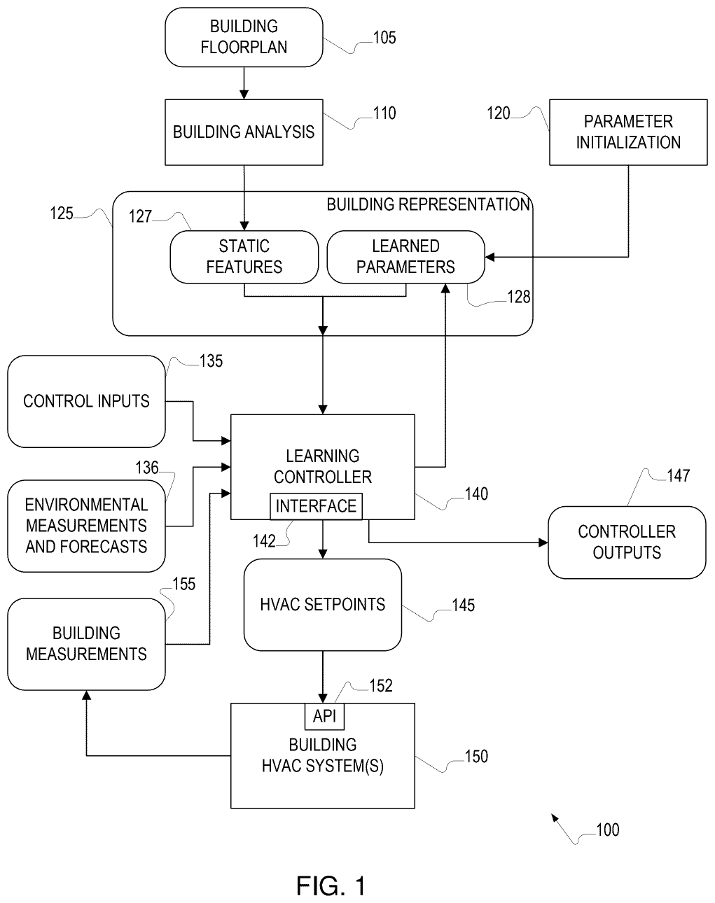

Referring to FIG. 1. A building control system 100 includes a building heating and ventilation (HVAC) system 150 (also referred to as a building management system (BMS)). The HVAC system operates according to HVAC setpoints 145, which may be considered as examples, to be thermostat settings (e.g., heating and/or cooling thresholds) in various controlled spaces of the building. (Note that references to a “building” are used to refer to a single structure as well as a multiple structures such as a campus.) The operational inputs are provided via an interface 152, such as a computer application programming interface (API), or other control interface over a communication link or network. In general, the control system 100 is not configured with specific aspects of the HVAC system 150, for example, and does typically not monitor internal operation of the HVAC system (e.g., settings of air dampers or hydronic valves). The HVAC system 150 does provide building measurements 155, generally including the actual temperatures corresponding to each of the controlled spaces. Very generally, the control system 100 can infer characteristics of the HVAC system 150 (i.e., including the building being controlled) using a history of the setpoints 145 and the resulting measurements 155.

Configuration of the building control system 100 begins with a building floorplan 105, which includes structural aspects of the spaces of the building (or of multiple buildings of a campus). For example, the floorplan defines the sizes (e.g., volumes) of spaces, which spaces are exposed to the exterior walls, which spaces are adjacent to one another through walls or floors, which spaces are open to one another by doors or openings, and so forth. This floorplan also identifies the association of particular setpoint inputs (e.g., thermostat setting) and sensors measurements (e.g., temperature sensor outputs) with spaces of the floorplan. This building floorplan 105 is processed in a building analysis procedure 110 to yield a building representation 125, which is a data representation suitable for use with a software-based learning controller 140. In some implementations, the building analysis procedure 110 is manual, and as presented later in this document, this procedure may optionally be fully or partially automated using rule-based and/or machine learning techniques.

The building representation 125 includes two parts. Static features 127 remain fixed during operation (e.g., dependent on the arrangement of spaces in a specific building), and represent a translation of the building floorplan to a form suitable for the controller 140. Learned parameters 128 include values for a set of parameters that are related to the static features 127, and that configure the operation of the controller 140 so that desired outputs are achieved by the building HVAC system 150. In at least some implementations, the building representation includes a graph specification in which nodes of the graph correspond to spaces in the building (or exterior spaces outside the building) and edges of the graph represent adjacency of spaces, where adjacency relates to influence of one space on another such as by heat and/or air transfer between the spaces.

The learning controller 140 makes use of the building representation 125, control inputs 135 (e.g., present desired temperatures and/or desired future temperatures), and building measurements 155 (e.g., actual temperatures) to determine the setpoints 145. In some examples, the controller 140 further makes use of environmental measurements and forecasts 136. These measurements and forecasts can include weather-related items such as output temperatures, solar irradiance, and wind, which may be associated with particular spaces (e.g., rooms on a sunny side of a building may have greater solar irradiance than on a shady location). These measurements can also include occupancy measurements for spaces (e.g., binary occupied vs. empty, or occupant counts), or CO₂ density (e.g., as a proxy for occupancy). The measurements may be for a present time, or may also be for times in the future based on predictions or known schedules. For example, externally generated (e.g., government provided or commercial) weather forecasts can be used, and occupancy may be measured and/or predicted by past patterns or by schedules (e.g., a reservation schedule for a meeting room or lecture hall).

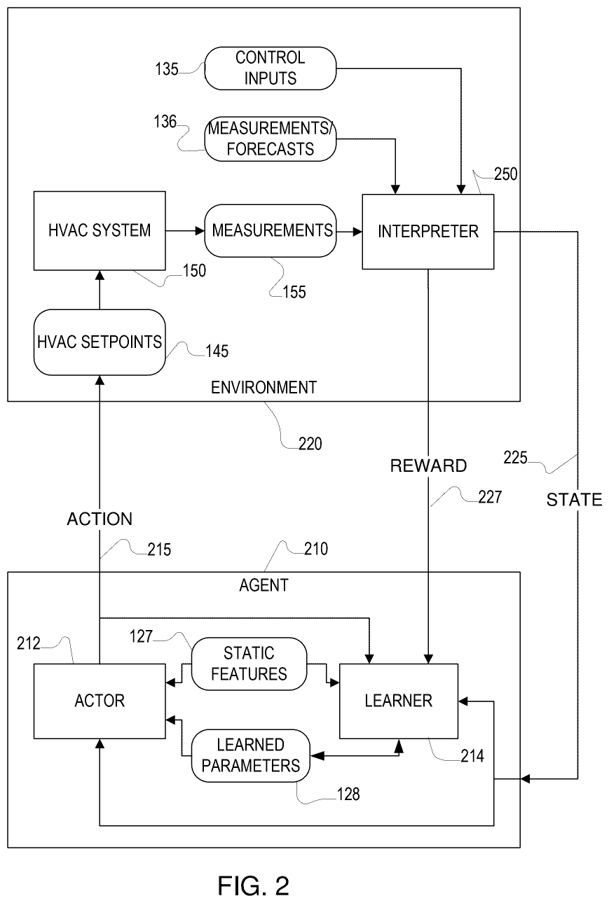

In operation (i.e., in an “online” mode of operation), the learning controller 140 both outputs the setpoints 145 and also updates the learned parameters 128 of the building representation. At least some implementations of the controller 140 use a reinforcement learning (RL) approach, as illustrated in FIG. 2. Generally, the elements illustrated in FIG. 1 can be arranged into an “environment” 220 and an “agent” 210. The agent 210 provides actions 215 to the environment, including the HVAC setpoints 145. The environment 220 provides in return a resulting state 225 of the environment, including the measurements 155 provided by the HVAC system 150. The environment also provides a “reward” 227, which characterizes how well the action achieved the goal of the agent, for instance the degree to which the measurements 155 match the control inputs 135 and/or other metrics such as the aggregate amount of energy used or carbon emitted by the HVAC system 150. At least conceptually, a computation element referred to as the interpreter 250 assembles and/or computes the reward 227 and state 225 based on the inputs and measurements 135, 136, and 155. The agent 210 includes an actor 212, which determines the output action 215 of the agent. This action is based on the state 225 returned from the environment, and depends on the learned parameters 128 as well as static features 127. A learner 214 updates the learned parameters 128 over time to improve the reward (on average) returned by the environment to improve the operation of the overall system. In FIG. 2, the learned parameters 128 are illustrated as both an input and an output for the learner 214 to show that the learner generally incrementally updates the parameters by using the current values of the parameters and providing new values to use as further time steps of the system operation. The actor 212 and learner 214, as well as the interpreter 250, can be considered to be constituents of the learning controller 140 of FIG. 1. The iteration of action-reward/state is repeated over time, for example periodically, such as once every 5 minutes.

Within the framework of FIG. 2, a number of specific implementations of reinforcement learning may be used. The differences between these implementations include differences in strategies for updating the learned parameters, differences in strategies in determining the actions, and the computational structures used within the actor, learner, and interpreter. In the discussion below, such computational structures may be referred to as “models” or “networks”, and may be described using mathematical notation for the operations performed by the structures, for the computational elements in the structures (which may be implemented as distinct physical elements, or implement by a processor that is configured by software instructions), and stored values or parameters that configure the computational structures. The term “network” or “neural network” refers to computational structures that are arranged in nodes and edges in a computational graph, generally with edges implementing numerical scaling operations and nodes implementing non-linear value transformations. The term “model” may refer to a computational element that approximates the behavior of a physical element, for example, a thermal model of a building may approximate the thermal response of a physical building to environmental and HVAC inputs.

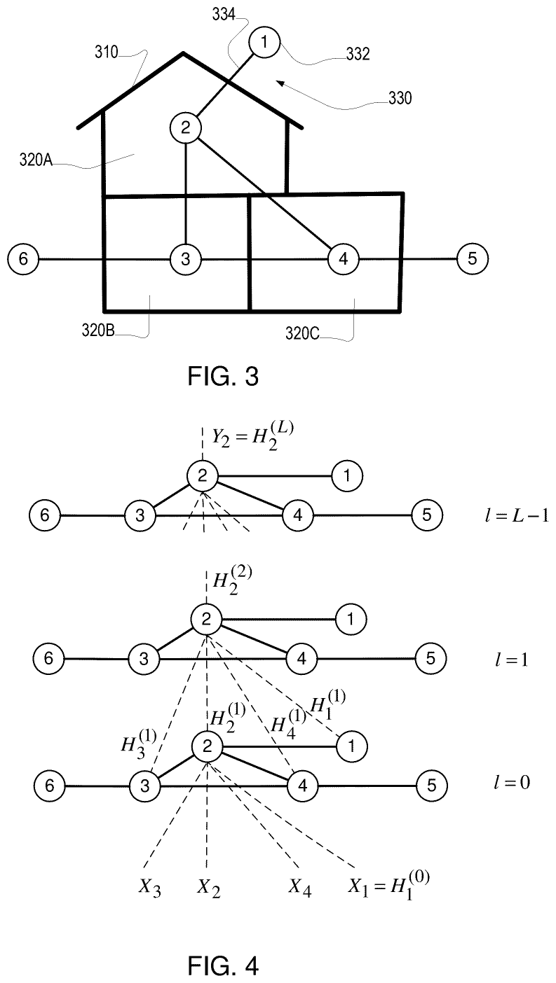

As introduced above, the building representation is graph-based. Referring to FIG. 3, a schematically represented building 310 has three controlled spaces 320A-C, for example, with each space having its own thermostat. A corresponding graph 330 has one node 332 per space, labelled 2, 3, and 4. Spaces that are “adjacent” have nodes that are linked by edges 334. Adjacency may be defined as there being some potential thermal interaction between the environment of one space and another, for example, because there may be heat transfer through a wall or floor separating the spaces, or because there may be an opening or a door that may open and close that may permit air transfer (and with it heat transfer) between the spaces. In FIG. 3, edges 2-3, 2-4, and 3-4 are such edges. In addition, in some implementations, the outside environment adjacent to each space is also assigned a node, for example, represented as nodes 1, 5, and 6, with edges to the corresponding nodes for the spaces. For example, edge 1-2 represents adjacency of space 320A and the outside environment adjacent to that space. For example, such an edge might correspond to possible heat transfer through windows (e.g., heating the space on a sunny day, or losing heat on a cold winter day). The set of nodes may be represented by a variable V (e.g., an ordered set of node that may be references by integer indices, for example, in the range 1 to N) and the set of edges be represented by a variable E (e.g., a set of (i, j) pairs of node indices). In some examples, the edges may be represented by an adjacency matrix A, such that A_{i,j}=1 if (i, j)∈E or i=j and 0 otherwise.

Approaches described below use computation structures referred to as graph neural networks (GNNs), and more specifically deep graph convolutional neural networks (GCNNs) for process input features associated with respective nodes (i.e., associated with spaces) to yield output features also associated with those nodes (i.e., associated with spaces), and potentially outputs that aggregate across all the nodes (i.e., associated with the building as a whole).

Referring to FIG. 4, an implementation of a GCNN has L layers of computational nodes (indexed from 0 to L-1), with each layer having one computational node corresponding to each node of the graph of FIG. 3. The input to the l^{th} layer is denoted H^{(l)} and the output of that layer is denoted H^{(l+1)}. The input to the GCNN is denoted X, which is equivalent to H⁽⁰⁾ and the output of the GCNN is Y=H^{(L)}. The value output features for a node at a particular layer, say

$${H}_{n}^{( l + 1 )}$$

is an aggregation function of the previous features of that node and its adjacent nodes. This can be represented as

$${H}_{i}^{( l + 1 )} = σ ( {ave}_{j : {A}_{i , j} = 1} ( {H}_{j}^{( l )} {W}^{( l )} ) ) ,$$

where σ is a non-linear activation function, and W^{(l)} is a “weight” matrix for layer l representing learnable parameters of the GCN. This computation can be represented as in matrix form for all the nodes as

$${H}^{( 1 + 1 )} = σ ( {D}^{- \frac{1}{2}} {AD}^{- \frac{1}{2}} {H}^{( l )} {W}^{( 1 )} ) ,$$

where D is a diagonal matrix with the degree for each node. In FIG. 4, representative successive computations of the output of node 2 are illustrated, along with the dependencies. For example, the output of node 2 on the l=0 layer,

$${H}_{2}^{( 1 )} ,$$

depends on the inputs of the adjacent nodes, namely X₁, X₂, X₃, and X₄. Similarly, the node 2 on the l=1 layer,

$${H}_{2}^{( 2 )} ,$$

depends on the intermediate values of the adjacent nodes, namely

$${H}_{1}^{( 1 )} , {H}_{2}^{( 1 )} , {H}_{3}^{( 1 )} , and {H}_{4}^{( 1 )} .$$

In an example of such an GCNN, the input Xᵢ for the i^{th} node may be a vector (e.g., rank 1 tensor) that includes the setpoint for the next time step (i.e., for the next 5 minutes) and optionally past setpoints, current and optionally historical room temperatures for the space corresponding to the node, and in the case of an outdoor node, outdoor temperature and irradiance. Optionally, the inputs Xᵢ for a node/space i can include known (i.e., static) characteristics of the space, for instance, the physical volume of the space, maximum heating or cooling capacity (e.g., in kBTU/hr). In some implementations, there may be unknown values associated with a space which are at least in part determined by a function of the known input, and the parameters (weights) of the function are inferred (estimated, updated) along with the weights of the GNN. Such additional values may be referred to as “latent” features for the spaces. While such variables may improve performance for a particular building, they would not in general be transferred directly to a new building because they are dependent on the specifics of the building where they were estimated.

In some implementations of the GCNN, characteristics of the edges (i.e., thermal interactions) are parameterized in the GCNN and/or have inputs that provide known characteristics of the interactions. For example, each edge may have a manually set or a learned weight, which is a number between 0.0 and 1.0 that characterizes a degree of interaction between the corresponding spaces. In the computations described above, the aggregation by averaging the impact of spaces joined by edges is effectively replaced by a weighted average. More generally, there may be known attributes of the interactions between spaces, such as area and insulation level of an adjoining wall, and the weights may depend at least in part on a learned function of the known characteristics. In yet other alternative, rather than a scalar weight, vectors associated with edges are propagated in the GCNN updates along with the node vectors. In the graph networks described above, the edges are used to define adjacency in the updating of node values of the GCNN. In an alternative graph neural network structure, the edges also have explicit or latent features that relate to the nature of the adjacency of the spaces. In some such cases, the output at a node depends on an input at that node, and an aggregation over the edges of that node of functions (e.g., linear transformations according to a weighting matrix) of a combination of the edge features for the edge and node features for the adjacent node, for example, being implemented using a message passing procedure.

The output Yᵢ for the node may be the prediction of the temperature for i^{th} space at the end of the time step. This GCNN may be referred to as a “thermal prediction model”. The outputs Yᵢ can have multiple components, for example, a predicted temperature, as well as a representation of predicted energy usage or generation characteristic, such as electrical watt-hours, heating or cooling kBTUs, or kilograms of carbon or CO₂ produced, attributed to that space. Such a representation may be explicit for each node/room and can be aggregated as a sum over all the nodes/rooms, or may be implicit forming an input to an aggregation function (e.g., a neural network) that is used to yield a system-wide energy usage or generation characteristic without those inputs necessarily explicitly representing physical quantities. In some alternatives, a single time-step of prediction is yielded by a single application of the model, while in other alternatives, a set of predictions, for example, 5, 10, 15, 20, etc. minutes into the future may be output as separate parts of the outputs. Rather than one model having multiple outputs for a fixed number of future time steps, another approach is for the thermal model to produce a successive outputs rather than a single or a fixed set of temperature output, while maintaining the same type of GCNN structure. One such approach uses a spatio-temporal graph convolutional network (STGCNN). In such an arrangement, at least conceptually there is a deep graph convolutional network associated with each future time step being predicted, and the output at a time step t for a node i at the layer l depends not only on the outputs at layer l−1 at time t for the adjacent nodes j, but also on the output for that node i at layer l at the previous time step t−1. In some such arrangements, the dependency on the previous time step makes use of a computational structure analogous to those in long short-term memory (LSTM) neural network architectures.

Given a training set of pairs (X,Y), where Y is the set of true temperatures, for example, resulting from monitoring behavior of the building under some control of the setpoints, the weights (i.e., parameter values) of the GCNN can be optimized to make the predicted temperatures match as closely as possible to the true temperatures in the training set. One such optimization procedure uses a gradient-based iteration to incrementally improve the values of the parameters during operation. Alternatively, the model may be trained in a batch mode prior to operation.

In operation, the GNN-based thermal prediction model may be used to assess the impact of changing setpoints (or other controllable inputs of the HVAC system), typically for multiple future time-steps in order to optimize the choice of those setpoints. One approach to controlling the setpoints is to use the thermal prediction model in a “model predictive control” procedure in which various setpoints may be considered for the next or for multiple future time steps (i.e., a finite horizon), and the best setpoints are chosen based on a search over possible values according to how closely the predicted temperatures match the desired temperatures in each space. However, such a search can be computationally expensive for a building with a large number of spaces, and depending on how far into the future the thermal prediction model is use, may not yield the best possible temperatures.

A preferable alternative is to use a second GCNN (i.e., in addition to the GCNN for the thermal prediction model) that accepts inputs, such as the Xᵢ, in the same manner as the thermal prediction model. However in this case, the output Yᵢ is the setpoints for the i^{th} space for the next time step. This second GCNN is referred to as a “policy” network (or an “actor” network). Referring back to FIG. 2, the actor 212 implements this policy network, the state 225 comprises the features Xᵢ for the nodes, and the action 215 comprises the setpoints output from the policy network. In FIG. 2, the learned parameters 128 comprise the weights of the GCNN, and the static features comprise the structure of the graph, including the adjacency information, number of spaces, etc., that fully specify the GCNN. In some implementations, the thermal model GCNN and the policy GCNN may share some parameters or structure (e.g., layers) rather than being entirely separate.

As introduced above, in the reinforcement learning approach illustrated in FIG. 2, the learner 214 adjust the learned parameters 218 according to rewards 227 computed by the interpreter 250. By convention, rewards are better if they are more positive. As an example, the reward for a time step may have a number of terms that are combined (e.g., added together). A first term may relate to the achieved temperatures in the spaces. In some examples, there is no explicit target temperature of the zones, and the temperature-related term penalizes setpoints that are outside a predefined “comfort zone” defined by a minimum and a maximum temperature that is deemed comfortable for occupants of the space. For example, this term may be zero if the actual temperature is in the comfort zone, and becomes progressively more negative as the temperature deviates from that zone. In some alternatives, the temperature-related term of the reward relates to an explicit controlled target temperature, and the reward is progressively more negative the more the actual temperature deviates from the target temperature. A second term may relate to an aggregated (i.e., not necessarily space-specific) energy usage or generation characteristic (e.g., as reported by the HVAC system, or based on aggregate energy used and fuel type consumed by the HVAC system). The overall reward may be a weighted additive combination of the terms, with multiplicative weights for the terms being set heuristically. One approach for the learner 214 is to incrementally update the learned parameters so that the expected future rewards (e.g., a decaying average discounted expectation of future rewards) is maximized. One form or reward has two terms: a first term related to how well the temperatures in the spaces are maintained, and a second term representing an aggregate energy usage or generation characteristics. These two terms may be summed, and weighted by scalar weighting factors that may be hand-set (fine-tuned) or may be automatically set using a hyperparameter tuning approach.

A number of implementations of the learned 214 can be used, with various alternatives exhibiting tradeoffs in computational requirements, convergence rates, optimality, etc. A number of possible implementations are described in detail in a textbook by Sutton and Barto, Reinforcement Learning: An Introduction, MIT Press, 2014, 2015. One approach to initializing the parameters of the models is to use random values; alternatively as described below, a transfer learning approach may be used in which parameter values from one building may be using as initial values for another building.

One implementation is a “soft actor-critic” (SAC) approach to learning. In this implementation, a “critic” network, also implemented as a GCNN, takes as input a combination of the state and the action at a time, and outputs the expected discounted future rewards resulting from taking that action at that state. Generally, on each time step, the parameter values of the policy network are updated to reinforce actions that exceed the expected reward predicted by the critic and reduces the likelihood of actions that do not. The parameters of the critic network are also updated to better match the actual reward that was achieved. Alternative reinforcement learning approaches may be used from those introduced above. For example, a thermal model may be used to make multi-step predictions to improve the action selected by the actor. Such techniques may be referred to as “rollout” approaches. In some such approaches, the parameters of the policy network may be updated based on the evaluation of the multiple time step prediction, or other “simulated experience” that is generated by the thermal model.

Use of an online reinforcement learning approach is not required. For example, one or more of the GCNNs may be periodically retrained in a “batch” mode after collecting operational data. Furthermore, data from multiple different buildings may be combined to train the shared weights of the GNNs, for example, in a multi-task learning approach.

In the approach described above, the weights of the GCNN are shared for processing at all of the nodes of the graphs, and therefore do not implicitly encode aspects of specific spaces, although overall characteristics of a building and its HVAC system may be. When initializing operation of a new building, it may nevertheless be effective to use the weights from another building as initial values of the learned GCNN parameters rather than random values. The new building will then incrementally update the learned parameter values from those initial values to tailor them specifically to the new build over time. Such an approach may be referred to as “transfer learning.” Note that in examples that make use of learned weights of the edges, the edge weights for the new building may be set manually based on similarity of the interactions between spaces in the previous building and the new building. In examples, where known (i.e., static) characteristics of spaces and edges are provided as inputs to the GCNN (e.g., with learned functions transforming these inputs to latent representations of nodes and edges), transferring the GCNN to a new building may be particularly effective.

In embodiments described above, the learning controller provides setpoints to the HVAC system, for example, using a computer-based application programming interface (API). The HVAC system then includes its own controllers that take the setpoints and control the heating and cooling devices. It should be understood that these setpoints are an example of a more general class of HVAC controller inputs. For example, rather than providing temperature-based setpoints, the output of the learning controller may include other values, such as coefficients for a local HVAC controller, for example, with the values determining coefficients for a PID controller. In this way, the delegated and distributed control of the HVAC for various spaces can work in combination with the overall (e.g., building- or campus-wide control of all the spaces) that provides both local responsive control as well as global optimization. Alternative embodiments are not necessarily for HVAC (heating ventilation and air conditioning), and it should be understood that an HVAC system is just one example of an environmental control system, which may additionally or alternatively control environmental aspects such as humidity, CO₂ level or density, etc. Furthermore, a “building” or a “campus” are examples of a multi-scape environmentally controlled by the approaches.

As introduced above, the building analysis procedure may be fully or partially automated. For example, a building may have computer-aided design (CAD) data representations of the spaces, often including not only the floorplan, but also having characteristics of walls etc. (e.g., thickness, insulation type, etc.). Because of the known structure of such CAD data, the transformation to a graph structure and optional node or edge specific (static) inputs can be implemented using computer-based rules. In some examples, artificial intelligence (AI) based processing of floorplan images can be trained to produce the graph representations, for example, implemented as a trained image processing transformation. Furthermore, inputs such as occupancy schedules may be automatically obtained by processing text material, for example, using large language model (LLM) approaches, thereby avoiding the manual labor as well as being able to adapt to changes without necessarily requiring human intervention.

Implementations of the approaches described above may make use of software. For example, non-transitory computer-readable media include instructions store on the media. The instructions, when executed by a computer processor cause the approach described above to be performed. The instructions may be low-level (e.g., machine-level) instructions tied to the instruction set of a particular physical or virtual processor or may be higher-level statements in a programming language that are interpreted or compiled into machine-level instructions. The processors may be general-purpose processors (e.g., central processing units, CPU), or may be processors that are particularly capable of implementing neural network computations, such as graphics processing units (GPUs). In at least some embodiments, the approaches are executed on computing devices that are remote from the HVAC system, for example, on a “cloud” server that is in data network (e.g., via the Internet) communication with the HVAC system via its API.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method of environmental control of spaces in one or more buildings, the method comprising:
determining a graph-based representation of the one or more buildings, said representation including nodes including node corresponding to spaces and edges including edges representing adjacency of spaces;
configuring a first graph convolutional neural network according to the graph-based representation to receive space-specific features, said features including environmental measurements for respective spaces, and to provide environmental control inputs to an environmental control system for the spaces;
repeating for successive time steps,
receiving environmental measurements for respective spaces measurements,
determining inputs to the first graph convolutional neural network from the received environmental measurements,
using the first graph convolutional neural network to determine the environmental control inputs for the environmental control system, and
providing the environmental control inputs to the environmental control system; and
for at least some of the time steps,
receiving aggregated energy-related measurements for the one or more buildings,
determining a quantity characterizing a quality of response to the environmental control inputs and the energy-related measurements, and
updating values of configurable parameters of the first graph convolutional neural network to improve the quality of response in future time steps.

2. The method of claim 1, wherein the environmental control system comprises a heating, ventilation, and air conditioning (HVAC) system, and wherein the environmental control inputs comprise temperature setpoints for said HVAC system.

3. The method of claim 1, wherein the updating of the configurable parameters of the first graph neural network comprises applying a reinforcement learning procedure using reward values determined from the quantity characterizing the quality of the response for successive time steps.

4. The method of claim 3, wherein the reward values each represents a weighted combination of a comfort term and an energy term.

5. The method of claim 3, wherein using the first graph convolutional neural network to determine the environmental control inputs includes using an actor-critic approach in which the first graph convolutional neural network implements an actor network, and a second graph convolutional neural network implements a critic network.

6. The method of claim 1, wherein determining the graph-based representation comprises processing an architectural layout of the one or more buildings.

7. The method of claim 6, wherein processing the architectural layout comprises applying a computer-implemented transformation of the architectural layout to produce the graph-based representation.

8. The method of claim 1, wherein at least some nodes of the building representation represent outside spaces adjacent to indoor spaces.

9. The method of claim 1, further comprises controlling environments of respective spaces using controller of the environmental control system with the environmental control inputs.

10. The method of claim 1, wherein providing the environmental control inputs to the environmental control system comprises providing said inputs via an application programming interface for the environmental control system.

11. The method of claim 1, wherein determining the inputs for the first graph convolutional neural network for spaces includes using one or more of external temperatures, interior temperatures, target temperatures, a CO₂ level, and occupancy information for respective spaces.

12. The method of claim 1, wherein the quantity characterizing a quality of response depends on one or more of an achieved temperature, an energy usage, and a CO₂ production for respective spaces.

13. The method of claim 1, further comprising:
determining a second graph-based representation of a second building separate from the one or more buildings, said representation including nodes including node corresponding to spaces and edges including edges representing adjacency of spaces of said second building; and
configuring a second graph convolutional neural network according to the second graph-based representation, including using configurable parameters of the first graph convolutional neural network to initialize configurable parameters of said second graph convolutional neural network.

14. A system for environmental control of spaces in one or more buildings comprising:
a learning controller configured according to a graph-based representation of the one or more buildings, said representation including nodes including node corresponding to spaces and edges including edges representing adjacency of spaces, wherein said controller comprises:
an interface for communicating with an environmental control system for said one or more buildings, said interface being for providing control inputs to said environmental control system and for receiving at least some environmental measurements for spaces of the one or more buildings;
storage for static features and learned parameters of a first graph convolutional neural network configured according to the graph-based representation;
an actor for processing environmental measurements using the first graph convolutional neural network to yield control inputs for providing to the environmental control system; and
a learner for updating the learned parameters using the environmental measurements; and
wherein controller is configured to repeat for successive time steps,
receiving environmental measurements for respective spaces,
determining inputs to the first graph convolutional neural network from the received environmental measurements,
using the first graph convolutional neural network to determine the environmental control inputs for the environmental control system, and
providing the environmental control inputs to the environmental control system; and
wherein controller is configured to repeat for at least some of the time steps,
determining a quantity characterizing a quality of response to the environmental control inputs, and
updating values of configurable parameters of the first graph convolutional neural network to improve the quality of response in future time steps.

15. A method for optimizing heating, ventilation, and air conditioning (HVAC) temperature setpoints in a multi-zone building, comprising:
constructing a graph representation of the building, wherein nodes correspond to individual thermal zones and edges represent thermal or spatial relationships between the zones;
collecting zone-specific data including temperature, occupancy, and environmental conditions;
collecting building-level aggregated energy usage or carbon emission information;
encoding the graph representation using a graph neural network to generate a dynamic state representation of the building;
training a reinforcement learning agent using the dynamic state representation to learn a control policy for adjusting HVAC temperature setpoints;
applying the control policy to update temperature setpoints through a building management system (BMS); and
employing transfer learning to adapt the trained model to one or more additional buildings or zone configurations.

16. The method of claim 15, The method of claim 1, wherein the reinforcement learning agent uses a deep reinforcement learning algorithm selected from the group consisting of proximal policy optimization (PPO), deep Q-learning (DQN), or actor-critic methods.

17. The method of claim 15, wherein the reward function used in reinforcement learning is a weighted sum of energy consumption and occupant discomfort.

18. The method of claim 15, wherein the system receives real-time updates from building sensors, including room temperature, occupancy counts, and outdoor weather conditions.

19. The method of claim 15, further comprising periodically retraining the reinforcement learning agent using updated operational data to improve policy performance over time.

20. The method of claim 15, wherein transfer learning comprises fine-tuning a pre-trained model using a reduced number of training episodes or samples from a new building or layout.
